(19) United States
(12) Patent Application Publication
(10) Pub. No.: US 2016/0286198 A1
(43) Pub. Date: Sep. 29, 2016

(54) APPARATUS AND METHOD OF CONVERTING IMAGE

(71) Applicant: ELECTRONICS AND TELECOMMUNICATIONS RESEARCH INSTITUTE, Daejeon (KR)

(72) Inventor: Yun-Ji BAN, Daejeon (KR)

(21) Appl. No.: 14/955,130

(22) Filed: Dec. 1, 2015

(30) Foreign Application Priority Data
Mar. 25, 2015 (KR) 10-2015-0041565

(51) Int. Cl. H04N 13/02; H04N 13/00; G06T 11/40

(52) U.S. Cl. CPC H04N 13/026; G06T 11/40; H04N 13/0271; H04N 13/0018

(57) ABSTRACT

An apparatus for transforming image includes: a depth map generating unit generating a depth map of a 2D image; a rendering unit rendering a left-eye image and a right-eye image depending on the depth map; a hole removing unit removing holes of the left-eye image and the right-eye image; and a synthesizing unit synthesizing the left-eye image and the right-eye image to render a 3D image.

### CROSS REFERENCE TO RELATED APPLICATION

This application claims the benefit of Korean Patent Application No. 10-2015-0041565, filed on Mar. 25, 2015, which is hereby incorporated by reference in its entirety into this application.

### BACKGROUND OF THE INVENTION

1. Technical Field

The present invention relates to a technology of converting an image, and more particularly, to a technology of converting a two-dimensional (2D) image into a three-dimensional (3D) image.

2. Description of the Related Art

Recently, in accordance with the development of a three-dimensional (3D) image device such as a 3D television (3DTV), and the like, a demand of a 3D image has increased. Therefore, a technology of rendering the 3D image has become important.

In terms of a cost, it is more economical to convert the already rendered two-dimensional (2D) image into the 3D image than to newly product the 3D image.

A 2D-3D converting technology is a technology (depth image based rendering (DIBR)) of performing processes of separating objects from a 2D image, assigning stereoscope depth to each object to generate a depth map, and rendering an image in a new view point based on the depth map to render an image having a 3D effect.

However, in the case in which a 3D image is rendered depending on the DIBR, a hole is frequently formed in the vicinity of the object, such that a case in which stereoscopic depth of the 3D image is unnatural often occurs. Therefore, a technology for filling the hole (removing the hole) in the 3D image rendered depending on the DIBR has been developed.

As a typical method of filling the hole, a linear interpolation method of simply interpolating the hole by left and right color values of the hole, a method of removing the hole by blurring a depth map to perform the DIBR, and an inpainting method of finding a surrounding texture most appropriate for the hole among surrounding textures and filling the hole with the found surrounding texture are mainly used.

In the existing methods, only a hole filling process for a single frame has been considered. However, in the case in which the respective frames are continuously reproduced, holes between the frames are filled with different values, such that a flickering problem may occur. In a method (interpolation) of simply interpolating the hole by the surrounding values, flickering may be decreased. However, a portion at which the hole is formed seems to be simply extended by the left and right values to deteriorate quality of the resultant 3D image.

In addition, in the case of performing a work of directly filling the hole by a manual work, there is an advantage that the 3D image is more elaborate and quality of the 3D image is more excellent than those of a method using an automatic algorithm. However, since a work of filling the hole is required every frame, a considerable amount of time is required in order to render the 3D image.

### SUMMARY OF THE INVENTION

An object of the present invention is to provide an apparatus and a method for transforming image capable of rendering a three-dimensional (3D) image in which flickering for hole regions is not generated.

According to an aspect of the present invention, there is provided an apparatus for transforming image, including: a depth map generating unit generating a depth map of a 2D image; a rendering unit rendering a left-eye image and a right-eye image depending on the depth map; a hole removing unit removing holes of the left-eye image and the right-eye image; and a synthesizing unit synthesizing the left-eye image and the right-eye image to render a 3D image.

The hole removing unit may render a reference image including all of holes included in the respective frames of the left-eye image and the right-eye image, fill hole regions of the reference image depending on textures corresponding to the hole regions in the case in which the textures corresponding to the hole regions among textures of the respective frames are present, fill hole regions of the reference image that do not correspond to the textures of the respective frames in a predefined scheme, and fill holes corresponding to the respective frames of the left-eye image and the right-eye image depending on the reference image.

The hole removing unit may fill the hole regions depending on textures having depth values less than threshold values corresponding to the hole regions among the textures corresponding to the hole regions.

The hole removing unit may set a window having a size corresponding to those of the holes of the reference image, set a target region including pixels having depth values smaller than threshold values corresponding to the holes of the reference image among pixels corresponding to the window, and fill the hole regions of the reference image that do not correspond to the textures of the respective frames in an inpainting scheme with respect to the target region.

According to another aspect of the present invention, there is provided a method for transforming image by an apparatus for transforming image, including: generating a depth map of a 2D image; rendering a left-eye image and a right-eye image depending on the depth map; removing holes of the left-eye image and the right-eye image; and synthesizing the left-eye image and the right-eye image to render a 3D image.

The removing of the holes of the left-eye image and the right-eye image may include: rendering a reference image including all of holes included in the respective frames of the left-eye image and the right-eye image; filling hole regions of the reference image depending on textures corresponding to the hole regions in the case in which the textures corresponding to the hole regions among textures of the respective frames are present; filling hole regions of the reference image that do not correspond to the textures of the respective frames in a predefined scheme; and filling holes corresponding to the respective frames of the left-eye image and the right-eye image depending on the reference image.

The filling of the hole regions of the reference image depending on the textures corresponding to the hole regions in the case in which the textures corresponding to the hole regions among the textures of the respective frames are present may be filling the hole regions depending on textures having depth values less than threshold values corresponding to the hole regions among the textures corresponding to the hole regions.

The filling of the hole regions of the reference image that do not correspond to the textures of the respective frames in the predefined scheme may include: setting a window having a size corresponding to those of the holes of the reference image; setting a target region including pixels having depth values smaller than threshold values corresponding to the holes of the reference image among pixels corresponding to the window; and filling the hole regions of the reference image that do not correspond to the textures of the respective frames in an inpainting scheme with respect to the target region.

### BRIEF DESCRIPTION OF THE DRAWINGS

FIG. 1 is a block diagram illustrating an apparatus for transforming image according to an exemplary embodiment of the present invention.

FIG. 2 is a flow chart illustrating processes of converting a two-dimensional (2D) image into a three-dimensional (3D) image by the apparatus for transforming image according to an exemplary embodiment of the present invention.

FIG. 3 is a flow chart illustrating processes of removing holes of a left-eye image and a right-eye image by the apparatus for transforming image according to an exemplary embodiment of the present invention.

FIG. 4 is a view illustrating a hole included in a left-eye image or a right-eye image rendered by the apparatus for transforming image according to an exemplary embodiment of the present invention and regions adjacent to the hole.

FIG. 5 is a view illustrating processes of rendering a reference image by the apparatus for transforming image according to an exemplary embodiment of the present invention.

FIG. 6 is a flow chart illustrating processes of filling hole regions of the reference image in the case in which textures corresponding to the hole regions of the reference image among textures of the respective frames are present, by the apparatus for transforming image according to an exemplary embodiment of the present invention.

FIG. 7 is a flow chart illustrating processes of filling the hole regions in an inpainting scheme by the apparatus for transforming image according to an exemplary embodiment of the present invention.

FIG. 8 is a view illustrating a window and a target region set by the apparatus for transforming image according to an exemplary embodiment of the present invention.

FIG. 9 is a view illustrating a computer system in which the apparatus for transforming image according to an exemplary embodiment of the present invention is implemented.

### DESCRIPTION OF THE EXEMPLARY EMBODIMENTS

The present invention may be variously modified and have several exemplary embodiments. Therefore, specific exemplary embodiments of the present invention will be illustrated in the accompanying drawings and be described in detail in the present specification. However, it is to be understood that the present invention is not limited to a specific exemplary embodiment, but includes all modifications, equivalents, and substitutions without departing from the scope and spirit of the present invention.

Further, in the present specification, it is to be understood that when one component is referred to as “transmitting” a signal to another component, one component may be directly connected to another component to transmit signal to another component or may transmit a signal to another component through any other components unless explicitly described to the contrary.

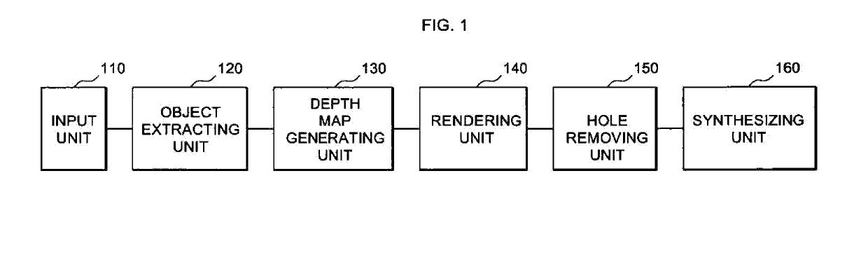

FIG. 1 is a block diagram illustrating an apparatus for transforming image according to an exemplary embodiment of the present invention.

Referring to FIG. 1, the apparatus for transforming image according to an exemplary embodiment of the present invention is configured to include an input unit 110, an object extracting unit 120, a depth map generating unit 130, rendering unit 140, a hole removing unit 150, and a synthesizing unit 160.

The input unit 110 receives a two-dimensional (2D) image from an external device (a camera, a terminal, a storage medium, or the like) through a predefined protocol. Here, the 2D image means an image that does not include a depth value for each pixel and includes a value for a color of each pixel. The input unit 110 transmits the 2D image to the object extracting unit 120.

The object extracting unit 120 performs a rotoscoping process of extracting one or more objects from the 2D image to generate object information. Here, the object information may be information indicating a region corresponding to the object in the 2D image. The object extracting unit 120 transmits the object information to the map generating unit 130.

The depth map generating unit 130 generates a depth map for each object corresponding to the object information.

The rendering unit 140 renders a left-eye image and a right-eye image corresponding to the depth map through a depth image based rendering (DIBR) process. The rendering unit 140 transmits the left-eye image and the right-eye image to the hole removing unit 150. Here, since the left-eye image and the right-eye image are images on the assumption of a view point different from that of the 2D image, the left-eye image and the right-eye image, may include holes positioned in the surrounding regions of the objects.

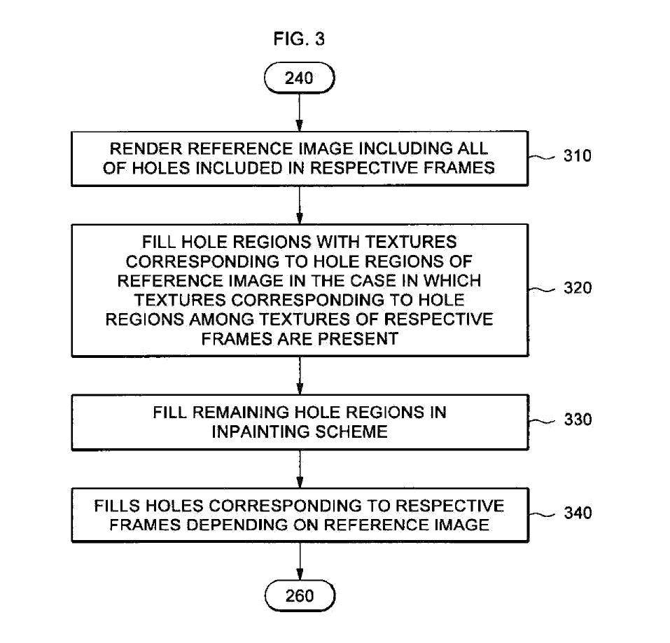

The hole removing unit 150 removes the holes included in the left-eye image and the right-eye image through a hole filling process. Processes of removing the hole by the hole removing unit 150 will be described in detail later with reference to FIG. 3. The hole removing unit 150 transmits the left-eye image and the right-eye image from which the holes are removed to the synthesizing unit 160.

The synthesizing unit 160 synthesizes the left-eye image and the right-eye image from which the holes are removed with each other to render a three-dimensional (3D) image. Here, the 3D image may be a stereoscopic image.

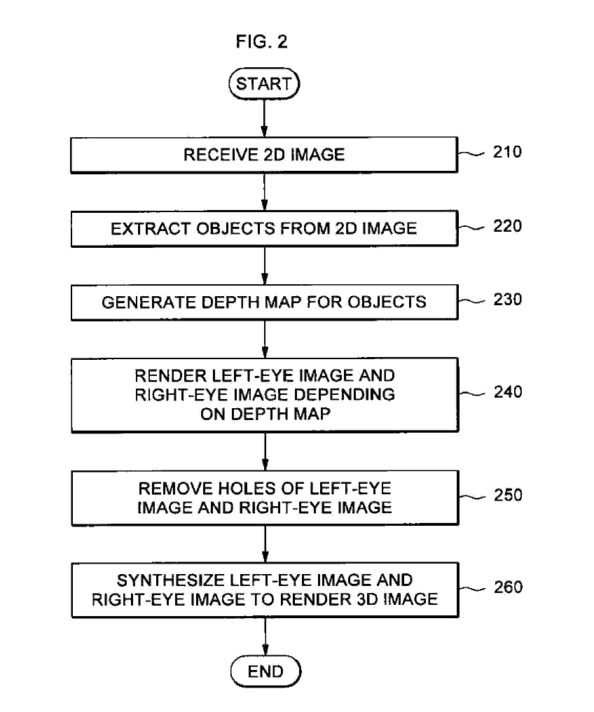

FIG. 2 is a flow chart illustrating processes of converting a 2D image into a 3D image by the apparatus for transforming image according to an exemplary embodiment of the present invention. Although the respective processes to be described below are performed by the respective functional units configuring the apparatus for transforming image, the subjects of the respective steps will be generally called the apparatus for transforming image in order to briefly and clearly describe the present invention.

Referring to FIG. 2, in Step 210, the apparatus for transforming image receives the 2D image from the external device.

In Step 220, the apparatus for transforming image extracts one or more objects from the 2D image.

In Step 230, the apparatus for transforming image generates the depth map for the objects.

In Step 240, the apparatus for transforming image renders the left-eye image and the right-eye image depending on the depth map. For example, the apparatus for transforming image may render the left-eye image and the right-eye image corresponding to the depth map through the DIBR process.

In Step 250, the apparatus for transforming image removes the holes of the left-eye image and the right-eye image. Processes of removing the holes of the left-eye image and the right-eye image by the apparatus for transforming image will be described in detail later with reference to FIG. 3.

In Step 260, the apparatus for transforming image synthesizes the left-eye image and the right-eye image with each other to render the 3D image.

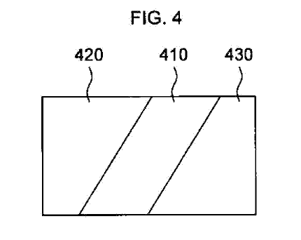

FIG. 3 is a flow chart illustrating processes of removing holes of a left-eye image and a right-eye image by the apparatus for transforming image according to an exemplary embodiment of the present invention, and FIG. 4 is a view illustrating a hole included in a left-eye image or a right-eye image rendered by the apparatus for transforming image according to an exemplary embodiment of the present invention and regions adjacent to the hole.

Referring to FIG. 3, in Step 301, the apparatus for transforming image renders a reference image including all of holes included in the respective frames of the left-eye image and the right-eye image. Here, the apparatus for transforming image calculates threshold values for the holes of the frames. For example, the apparatus for transforming image may calculate an average of depth values of regions 420 and 430 adjacent to a hole 410 as a threshold value for the corresponding hole 410, as illustrated in FIG. 4.

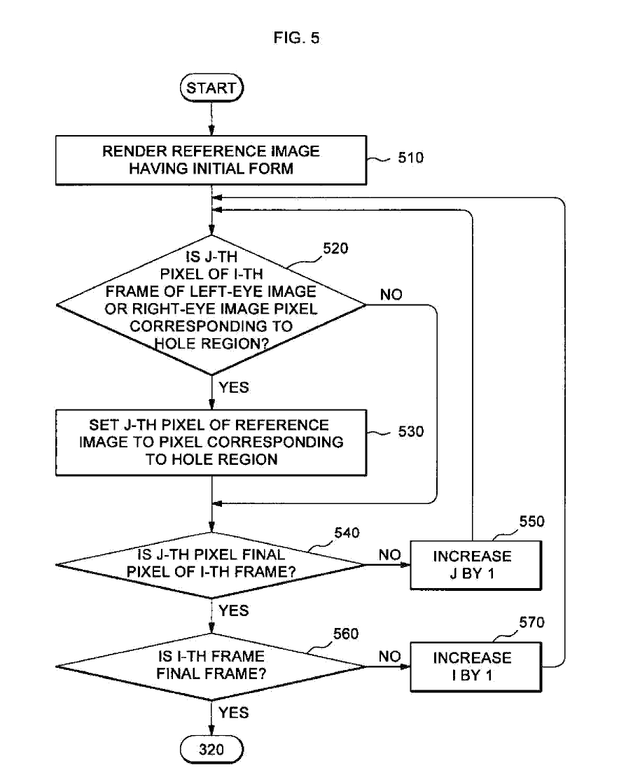

In Step 320, the apparatus for transforming image fills hole regions of the reference image with textures corresponding to the hole regions of the reference image in the case in which the textures corresponding to the hole regions of the reference image among textures of the respective frames are present. Processes of filling the hole regions in the case in which the textures corresponding to the hole regions of the reference image among the textures of the respective frames are present by the apparatus for transforming image will be described in detail later with reference to FIG. 5.

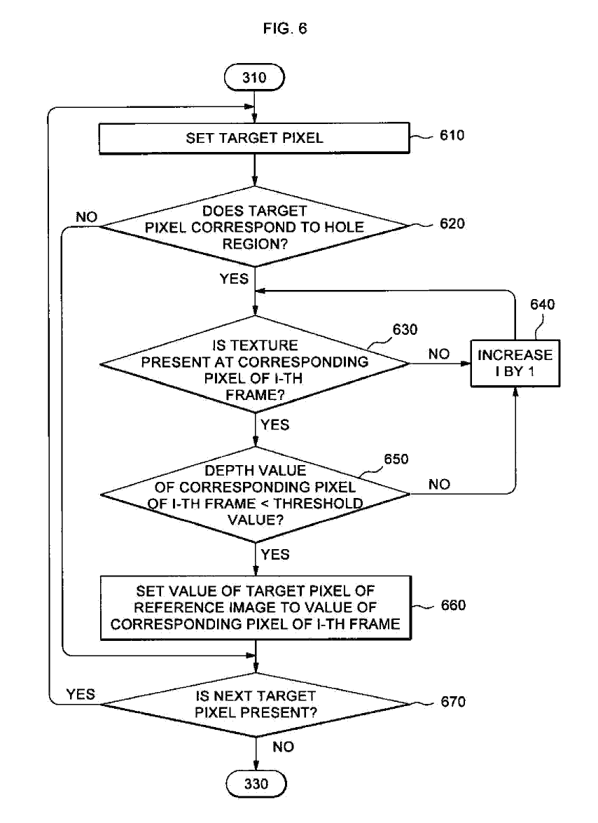

In Step 330, the apparatus for transforming image fills the remaining hole regions in an inpainting scheme. Processes of filling the hole regions in the inpainting scheme by the apparatus for transforming image will be described in detail later with reference to FIG. 6.

In Step 340, the apparatus for transforming image fills regions corresponding to the holes of the respective frames with reference to the reference image. For example, the apparatus for transforming image fills the corresponding hole regions with the textures of the reference image corresponding to the hole regions of the respective frames.

FIG. 5 is a view illustrating processes of rendering a reference image by the apparatus for transforming image according to an exemplary embodiment of the present invention. The respective processes to be described below are a process corresponding to Step 310 of FIG. 3 described above. In addition, the respective processes to be described below may be performed on each of the left-eye image and the right-eye image.

Referring to FIG. 5, in Step 510, the apparatus for transforming image renders a reference image having an initial form. Here, the reference image having the initial form may be an image that has the same resolution as that of the left-eye image or the right-eye image and does not have a value of each pixel or has a predefined initial value.

In Step 520, the apparatus for transforming image decides whether or not a j-th pixel of an i-th frame of the left-eye image or the right-eye image is a pixel corresponding to the hole region. Here, i and j are natural numbers of 1 or more, and may have 1 as initial values.

In the case in which it is decided in Step 520 that the j-th pixel of the i-th frame of the left-eye image or the right-eye image is the pixel corresponding to the hole region, the apparatus for transforming image sets a j-th pixel of the reference image to the pixel corresponding to the hole region in Step 530.

In the case in which it is decided in Step 520 that the j-th pixel of the i-th frame of the left-eye image or the right-eye image is not the pixel corresponding to the hole region, the apparatus for transforming image decides whether or not the j-th pixel is a final pixel of the i-th frame in Step 540.

In the case in which it is decided in Step 540 that the j-th pixel is not the final pixel of the i-th frame, the apparatus for transforming image increases j by 1 in Step 550. Then, the apparatus for transforming image performs the processes from Step 520.

In the case in which it is decided in Step 540 that the j-th pixel is the final pixel of the i-th frame, the apparatus for transforming image decides whether or not the i-th frame is a final frame of the left-eye image or the right-eye image in Step 560.

In the case in which it is decided in Step 560 that the i-th frame is not final frame of the left-eye image or the right-eye image, the apparatus for transforming image increases i by 1 and initializes a value of j to 1 in Step 570. Then, the apparatus for transforming image performs the processes from Step 520.

In the case in which it is decided in Step 560 that the i-th frame is the final frame of the left-eye image or the light-eye image, the apparatus for transforming image completes the processes of rendering the reference image and performs the process corresponding to Step 320 of FIG, 3 described above.

FIG. 6 is a flow chart illustrating processes of filling hole regions of the reference image in the case in which textures corresponding to the hole regions of the reference image among textures of the respective frames are present, by the apparatus for transforming image according to an exemplary embodiment of the present invention.

Referring to FIG. 6, in Step 610, the apparatus for transforming image sets a target pixel on which a filling process is to be performed among pixels of the reference image. Here, the apparatus for transforming image may sequentially set pixels that are not set to the target pixel in the previous step to the target pixel in a sequence according to a predefined rule.

In Step 620, the apparatus for transforming image decides whether or not the target pixel corresponds to the hole region of the reference image.

In the case in which it is decided in Step 620 that the target pixel does not correspond to the hole region of the reference image, the apparatus for transforming image performs a process from Step 670.

In the case in which it is decided in Step 620 that the target pixel corresponds to the hole region of the reference image, the apparatus for transforming image decides whether or not a texture is present at a corresponding pixel of the i-th frame (i is a natural number of 1 or more and has an initial value of 1) of the left-eye image or the right-eye image in Step 630. Here, the corresponding pixel of the i-th frame means a pixel of texture present at the same position as that of the target pixel among pixels of the i-th frame.

In the case in which it is decided in Step 630 that the texture is not present at the corresponding pixel of the i-th frame, the apparatus for transforming image increases a value of i by 1 in Step 640. Then, the apparatus for transforming image repeatedly performs the processes from Step 630.

In the case in which it is decided in Step 630 that the texture is present at the corresponding pixel of the i-th frame, the apparatus for transforming image decides whether or not a depth value of the corresponding pixel of the i-th frame is less than a threshold value of a hole corresponding to the target pixel in Step 650.

In the case in which it is decided in Step 650 that the depth value of the corresponding pixel of the i-th frame is the threshold value or more of the hole corresponding to the target pixel, the apparatus for transforming image repeatedly performs the processes from Step 640.

In the case in which it is decided in Step 650 that the depth value of the corresponding pixel of the i-th frame is less than the threshold value of the hole corresponding to the target pixel, the apparatus for transforming image sets a value of a target pixel of the reference image to be the same as that of the corresponding pixel of the i-th frame in Step 660.

In Step 670, the apparatus for transforming image decides whether or not the next target pixel is present in the reference image.

In the case in which it is decided in Step 670 that the next target pixel is present in the reference image, the apparatus for transforming image again performs the processes from Step 610.

In the case in which it is decided in Step 660 that the next target pixel is not present in the reference image, the apparatus for transforming image performs Step 330 described above with reference to FIG. 3.

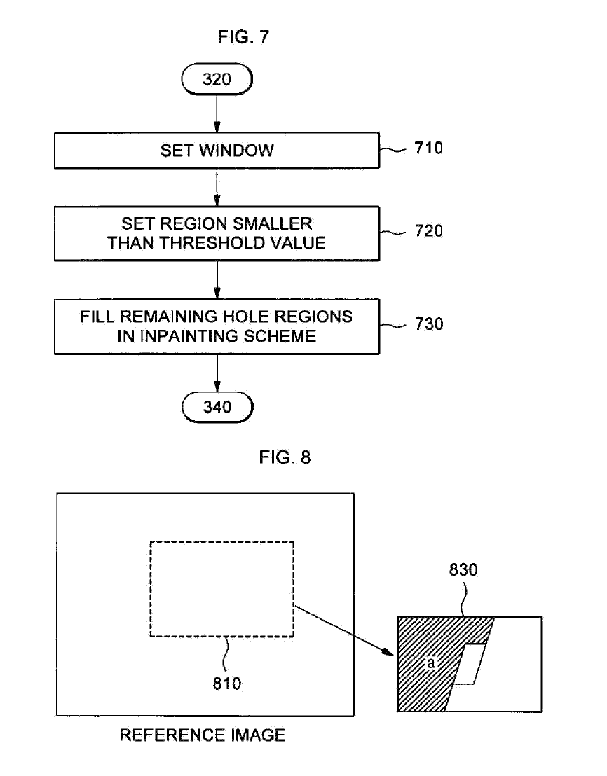

FIG. 7 is a flow chart illustrating processes of filling the hole regions in an inpainting scheme by the apparatus for transforming image according to an exemplary embodiment of the present invention, and FIG. 8 is a view illustrating a window and a target region set by the apparatus for transforming image according to an exemplary embodiment of the present invention.

Referring to FIG. 7, in Step 701, the apparatus for transforming image sets a window for the respective holes of the reference image. For example, the apparatus for transforming image may set a window having a horizontal size and a vertical size larger than those of the respective holes by a predefined numerical value. For example, the apparatus for transforming image may set a window 810 depending on a size of the hole in the reference image, as illustrated in FIG. 8.

In Step 720, the apparatus for transforming image sets a target region (for example, 830 of FIG. 8), which is a region including pixels having depth values smaller than threshold values for the respective holes of the reference image in a region corresponding to the window of the reference image.

In Step 730, the apparatus for transforming image fills the remaining hole regions in the inpainting scheme with reference to the target region.

The apparatus for transforming image according to an exemplary embodiment of the present described above may be implemented by a computer system.

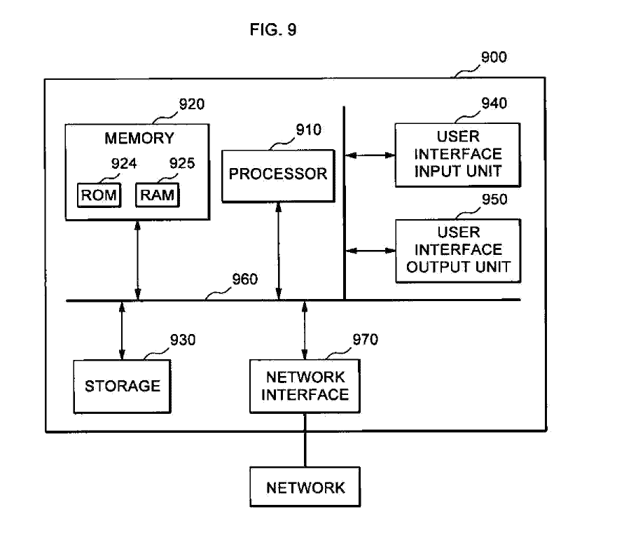

FIG. 9 is a view illustrating a computer system in which the apparatus for transforming image according to an exemplary embodiment of the present invention is implemented.

An exemplary embodiment according to the present invention may be implemented by, for example, a computer-readable recording medium in the computer system. As illustrated in FIG. 9, the computer system 900 may include at least one of one or more processors 910, a memory 920, a storing unit 930, a user interface input unit 940, and a user interface output unit 950, which may communicate with each other through a bus 960. In addition, the computer system 900 may further include a network interface 970 for accessing a network. The processor 910 may be a central processing unit (CPU) or a semiconductor element executing processing commands stored in the memory 920 and/or the storing unit 930. The memory 920 and the storing unit 930 may include various types of volatile/non-volatile storage media. For example, the memory may include a read only memory (ROM) 924 and a random access memory (RAM) 925.

As described above, according to an exemplary embodiment of the present invention, a 3D image in which flickering is not generated may be rendered without performing a manual work of a user.

In addition, according to an exemplary embodiment of the present invention, computational complexity for conversion of an image may be decreased through a process of filling all holes of the image based on a reference image.

Hereinabove, the present invention has been described with reference to exemplary embodiments thereof. Many exemplary embodiments other than the above-mentioned exemplary embodiments fall within the scope of the present invention. It will be understood by those skilled in the art to which the present invention pertains that the present invention may be implemented in a modified form without departing from essential characteristics of the present invention. Therefore, the exemplary embodiments disclosed herein should be considered in an illustrative aspect rather than a restrictive aspect. The scope of the present invention should be defined by the following claims rather than the above-mentioned description, and all technical spirits equivalent to the following claims should be interpreted as being included in the present invention.

What is claimed is:

1. An apparatus for transforming image, comprising:
a depth map generating unit generating a depth map of a two-dimensional (2D) image;
a rendering unit rendering a left-eye image and a right-eye image depending on the depth map;
a hole removing unit removing holes of the left-eye image and the right-eye image; and
a synthesizing unit synthesizing the left-eye image and the right-eye image to render a three-dimensional (3D) image.

2. The apparatus for transforming image of claim 1, wherein the hole removing unit renders a reference image including all of holes included in the respective frames of the left-eye image and the right-eye image, fills hole regions of the reference image depending on textures corresponding to the hole regions in the case in which the textures corresponding to the hole regions among textures of the respective frames are present, fills hole regions of the reference image that do not correspond to the textures of the respective frames in a predefined scheme, and fills holes corresponding to the respective frames of the left-eye image and the right-eye image depending on the reference image.

3. The apparatus for transforming image of claim 2, wherein the hole removing unit fills the hole regions depending on textures having depth values less than threshold values corresponding to the hole regions among the textures corresponding to the hole regions.

4. The apparatus for transforming image of claim 2, wherein the hole removing unit sets a window having a size corresponding to those of the holes of the reference image,
sets a target region including pixels having depth values smaller than threshold values corresponding to the holes of the reference image among pixels corresponding to the window, and fills the hole regions of the reference image that do not correspond to the textures of the respective frames in an inpainting scheme with respect to the target region.

5. A method for transforming image by an apparatus for transforming image, comprising:
generating a depth map of a 2D image;
rendering a left-eye image and a right-eye image depending on the depth map;
removing holes of the left-eye image and the right-eye image; and
synthesizing the left-eye image and the right-eye image to render a 3D image.

6. The method for transforming image of claim 5, wherein the removing of the holes of the left-eye image and the right-eye image includes:
rendering a reference image including all of holes included in the respective frames of the left-eye image and the right-eye image;
filling hole regions of the reference image depending on textures corresponding to the hole regions in the case in which the textures corresponding to the hole regions among textures of the respective frames are present;
filling hole regions of the reference image that do not correspond to the textures of the respective frames in a predefined scheme; and
filling holes corresponding to the respective frames of the left-eye image and the right-eye image depending on the reference image.

7. The method for transforming image of claim 6, wherein the filling of the hole regions of the reference image depending on the textures corresponding to the hole regions in the case in which the textures corresponding to the hole regions among the textures of the respective frames are present is filling the hole regions depending on textures having depth values less than threshold values corresponding to the hole regions among the textures corresponding to the hole regions.

8. The method for transforming image of claim 6, wherein the filling of the hole regions of the reference image that do not correspond to the textures of the respective frames in the predefined scheme includes:
setting a window having a size corresponding to those of the holes of the reference image;
setting a target region including pixels having depth values smaller than threshold values corresponding to the holes of the reference image among pixels corresponding to the window; and
filling the hole regions of the reference image that do not correspond to the textures of the respective frames in an inpainting scheme with respect to the target region.
